(19) United States
(12) Patent Application Publication
(10) Pub. No.: US 2012/0197816 A1
(43) Pub. Date: Aug. 2, 2012

(54) PRODUCT REVIEW BIAS IDENTIFICATION AND RECOMMENDATIONS

(75) Inventors: Gregory T. Short, Carlsbad, CA (US); Geoffrey C. Zatkin, Encinitas, CA (US); Theodore Spence, Oceanside, CA (US); Jesse Divnich, Carlsbad, CA (US); Shane Hebard-Massey, San Diego, CA (US)

(73) Assignee: ELECTRONIC ENTERTAINMENT DESIGN AND RESEARCH, Carlsbad, CA (US)

(21) Appl. No.: 13/357,428

(22) Filed: Jan. 24, 2012

Related U.S. Application Data
(60) Provisional application No. 61/436,758, filed on Jan. 27, 2011.
(60) Provisional application No. 61/436,815, filed on Jan. 27, 2011.

(51) Int. Cl. G06Q 30/02

(52) U.S. Cl. 705/347

(57) ABSTRACT

Review bias identification systems and methods are presented. A bias in one or more review elements can be identified by deriving a measure of how a review outlet's product review deviates from an industry average or composite review of the product. A bias engine generates a bias vector for a review outlet where the vector can include multiple bias metrics associated with one or more product properties. The bias engine can further present one or more recommendations of associating the product with a review outlet based on the bias vector.

This application claims the benefit of priority to U.S. provisional applications 61/436,758 and 61/436,815 both filed on Jan. 27, 2011. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is marketing analytics technologies.

### BACKGROUND

In general, positive product reviews can stimulate sales of a product and negative product reviews can diminish sales of a product. Media outlets that provide product reviews often have bias for specific types of products or that have specific features. Providing an indication to consumers that bias exists helps the consumer make informed decisions. In addition, providers of goods and services can also use indications of bias to guide their products to an appropriate media outlet for promotion.

Others have put forth effort to detect bias in reviews. For example, U.S. patent application publication 2010/0274791 to Chow et al. titled “Web-Based Tool for Detecting Bias in Reviews”, filed Apr. 28, 2009, describes estimating a bias based on comparing the number of search results obtained from web-based queries where the queries are construct to obtain web documents referencing a specific reviewer and/or an entity that is reviewed. However, such approaches fail to provide a quantitative measure of how a review outlet might be biased toward specific goods or services or an aspect of goods or services. Further, Chow lacks any insight into mapping a bias measure into recommendations for a product provider.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for identification of bias in reviews.

### SUMMARY OF THE INVENTION

The inventive subject matter provides apparatus, systems and methods in which bias can be identified among review outlets and can be used to recommend an association between a review outlet and a product of interest. One aspect of the inventive subject matter includes comparing product reviews from multiple review outlets to create a composite review score. The review score can be a single valued or can be a multi-valued vector having elements corresponding to product properties. Each review outlet can also be assigned a bias vector indicating how the review outlet's reviews deviate from the composite review score. In some embodiments, the composite review score can incorporate data from a target review outlet, while in other embodiments the data from the target review outlet can be removed from the analysis. A bias vector (e.g., a metric having one or more values) can be constructed indicating the review outlet's bias according to one or more product properties. A recommendation for associating a product with a review outlet can be generated based on the bias vector.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of bias identification system.

FIG. 2 is a schematic of a method for identifying bias associated with product reviews.

### DETAILED DESCRIPTION

It should be noted that while the following description is drawn to a computer/server based bias identification systems, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including providing one or more network-based signals that configures an output device to present a recommendation for associating a review outlet with a product.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of networking, “coupled to” and “coupled with” are also construed to mean “communicatively coupled with” over a network connection, possibly via one or more intermediary networking nodes.

The following discussion presents the inventive subject matter from the perspective a identifying review bias with respect to video games. However, one should appreciate that the inventive subject matter can be applied to other markets beyond the video games and can be suitable for use with other goods or services. Example alternative products include automobiles, movies, books, board games, restaurants, air lines, dry cleaners, or other goods or services. Further, the following discussion relates to review outlets (e.g., reviewers, magazines, blogs, web sites, forum communities, etc.). However, the inventive subject can also be applied to media outlets (e.g., chain stores, brick and mortar stores, on-line sites, etc.).

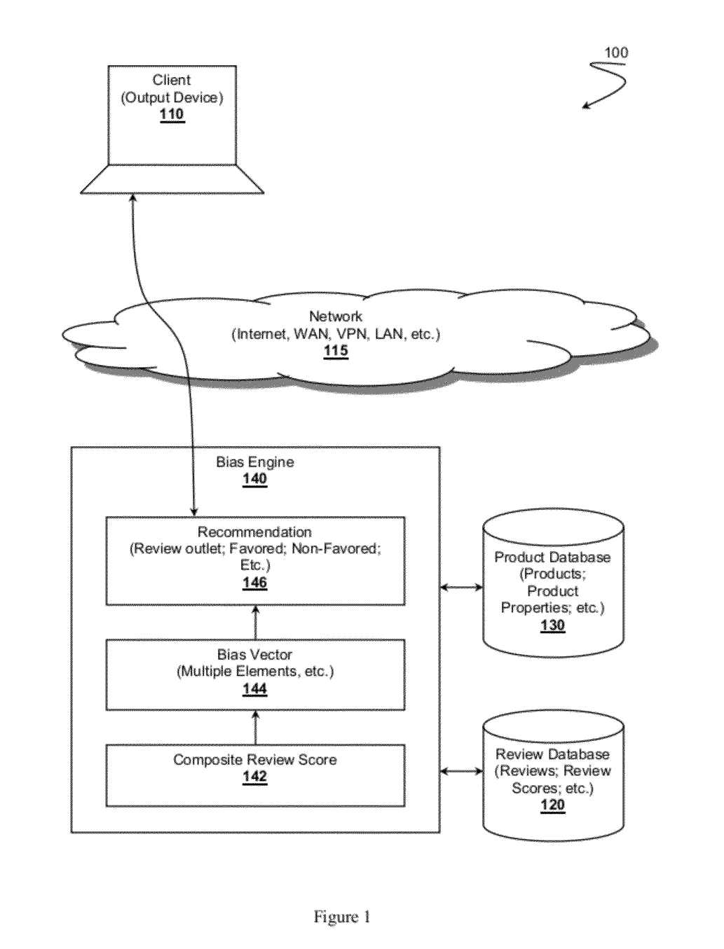

In FIG. 1 bias identification system 100 can operate as a for-fee service for one or more of client 110. Client 110 can subscribe to the service or otherwise pay a fee use the capabilities of the service to determine if one or more review outlets (e.g., reviewers, blogs, web sites, individuals, endorsers, etc.) have a bias with respect to one or more product properties. Preferably bias identification system 100 comprises bias engine 140 coupled with review database 120 and product database 130. In more preferred embodiments, the elements of bias identification system 100 are communicatively coupled via network 115.

Review database 120 preferably stores review objects where each review object represents a review of one or more goods or services. In some embodiments, the review objects can be stored in a serialized fashion, possibly as an XML file, or even as an N-tuple of data. Review objects further comprise one or more attributes associated with the reviewer, review outlet (e.g., blog, web site, news story, forum posts, etc.), products that are reviewed, time, or other information relating the review. An especially preferred review attribute comprises a review score that represents a quantification of the review results with respect to a product property.

Review scores can be single valued or multi-valued. An example single valued review score could include a rating in a range (e.g., one to ten, zero to five stars, etc.), an absolute value or measurement (e.g., number of thumbs up, number of thumbs down, a ratio of positive to negative reviews, number of comments or forum posts, etc.), or other types of single valued scores. Multi-valued review scores can include multiple measures reflecting different aspects of a review. For example, a video game can have multiple properties, each of which could have a separate review score. The game could be rated for its art, game play, difficulty, age rating appropriateness, or other factors.

In some embodiments, review scores are simply obtained directly from a review outlet's review. In other embodiments, the review scores are calculated based on content from the review itself. A commenter might state that a video game is “fantastic”, which can be mapped to a normalized score; possibly a value within a normalization range between zero and 100 for example. Such mapping can be achieved through one or more rule sets that can embody an a priori established mapping criteria based on surveys of game players.

Product database 130 preferably stores one or more product objects representing goods or services offered by vendors. Product objects include product properties describing the nature of the corresponding good or service. For example, a product object representing a video game could have a wide range of properties including genre, category, size, shape, color, awareness of the market, marketing spend, developer, publisher, product manager, or other information relating to the specific video game. Although it is possible for a product object to represent a type or classification of product (e.g., video games per se), in more preferred embodiments, a product object represents a specific good or service (e.g., The Elder Scrolls: Skyrim by Bethesda Games Studios).

Collection or management of review attributes and product properties can be handled through various techniques. Co-owned U.S. Pat. No. 7,580,853 to Short et al. titled “Methods of Providing a Marketing Guidance Report for a Proposed Electronic Game”, filed Apr. 13, 2007, describes suitable techniques for collection, management, or analysis of attributes and properties. The techniques described in U.S. Pat. No. 7,580,853 can be suitably adapted for use with the inventive subject matter.

Bias engine 140 couples with review database 120 and product database 130 to operate as a bias identification system for remote clients 110. In more preferred embodiments, bias engine 140 operates at the heart of a for-fee service. An example service having access to myriad video game-related and review data that can be adapted for use as within disclosed ecosystem includes the services or servers offered by Electronic Entertainment Design and Research™ (see URL www.eedar.com).

Bias engine 140 represents an analysis engine configured to analyze review objects with respect to product objects to determine if one or more review outlets have a measurable bias to types of products, specific products, product properties, or other aspects of products. Bias engine 140 aggregates review scores derived from relevant review objects associated with one or more products having a common product property. For example, client 110 might query the system to run an analysis with respect to First Person Shooter (FPS) video games. Bias engine 140 would aggregate review objects associated with video game product objects that have a product property of “Genre:FPS”. Bias engine 140 aggregates the review scores to form composite review score 142.

Composite review score 142 represents a global measure of how all relevant reviews rated or otherwise reviewed specified products or product properties. As with review scores, composite review score 142 can be single valued or multi-valued. In some embodiments, composite review score 142 can be a simple average over all review objects. However, it is also contemplated that composite review score 142 can be derived by weighting the constituent review scores. For example, review scores could be down weighted up weighted based on how the review outlet has been rated as a reviewer by review readers.

An example multi-valued composite review score 142 could include an N-tuple, vector, or matrix including multiple members, each member reflecting an aggregated review scores for each type of product property. Thus, composite review score 142 can provide an indication how each aspect of product properties were received by numerous review outlets over all. Further, each member can include statistical information about the aggregated information possibly including number of data points, an average, a mode, a standard deviation, a Chi-square fit value to a trend, or other statistical information. One should appreciate that composite review score 142 represents a global view of products or specific product properties.

Bias engine 140 generates bias vector 144 for a review object where bias vector 144 relates to a review outlet associated with a specific review object. Preferred bias vector 144 comprises one or more bias metrics reflecting how the specific review object deviates from the composite review score 142. Thus, bias vector 144 illustrates how the review outlet might be biased relative to the global perspective with respect to a product or to multiple individual product properties.

Bias Vector 144 provides an indication or measure of how a specific review outlet deviates away from the global “norm”. One should further appreciate that the bias metrics composing bias vector 144 can be based on multiple review objects. For example, PC Gamer® magazine, a specific review outlet, could have thousands of reviews for FPS games. Thus, a corresponding bias vector 144 associated with PC Gamer magazine could include a statistical measure indicating if PC Gamer as an review outlet has a bias by providing favorable reviews or unfavorable reviews for FPS games or other game properties.

Bias engine 140 can leverage bias vector 144 to offer insight to product producers; game developers or publishers for example, on which review outlets might be most favorable or relevant to their product. Bias engine 140 constructs recommendation 146 based on the information available in bias vector 144 and a target product. Recommendation 146 can include a recommendation of associating a product corresponding with a product object with a review outlet or a recommendation of avoiding association of a corresponding with a product object with a review outlet.

The recommendation on an association or avoidance can be determined through applying one or more rules or recommendation criteria to bias vector 144. One example criteria might include providing a strong recommendation for association (avoidance) if a bias metric is more than one standard deviation above (below) the mean aggregated review score associated with the same bias metric. In some embodiments, client 110 can define their preferred criteria or can utilize an a priori defined set of criteria.

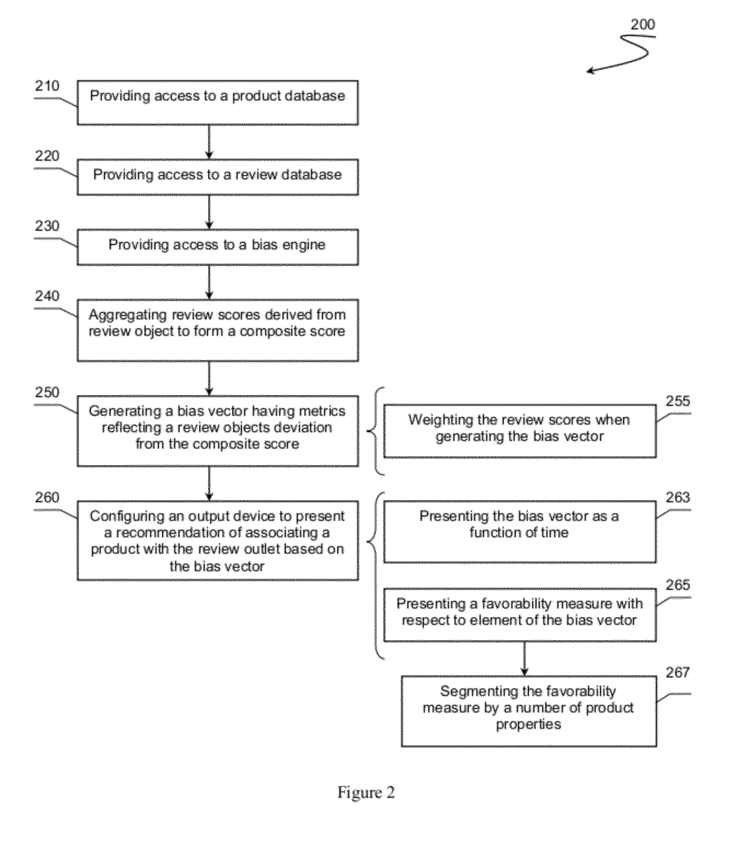

One aspect of the inventive subject matter is considered to include method 200 illustrated in FIG. 2 of determining the suitability of submitting a product to be reviewed to a review outlet (e.g., magazine, blog, on-line community, etc.) based on identifying review bias.

Step 210 includes providing access to one or more product databases storing a plurality of product objects where the product objects each have product properties. The product database is preferably accessible to a bias engine over a network. In some embodiments, the product database can be a publicly accessible database (e.g., Amazon®, eBay®, etc.) while in other embodiments the product database can be a proprietary database. The product database can be accessed once suitable authentication or authorization, if any, have been granted. The product properties can include a broad spectrum of information about the product. For example product properties can conform to a universal namespace where each properties includes an (attribute, value)-pair ranging from genre or product type, to specific names of individuals that participated in the creation of a product (e.g., publisher, distributor, creative lead, director, producer, etc.). For example, game properties could include genre, category, size, shape, color, awareness, features, target demographics, or marketing spend.

Step 220 includes providing access to a review database storing a plurality of review objects, each review object representative of a product review of a product object and from a review outlet. The review objects preferably have attributes that describe the nature of the review object. For example, the attributes can include a name of the reviewer, name of the review outlet, review scores, or other information associated with the review. The review database could also comprise public databases (e.g., review web sites, Amazon®, etc.) or a proprietary database.

Step 230 includes providing access to a bias engine communicatively coupled with the product database and review database possibly over a network (e.g., the Internet). Preferably one or more clients access the services offered by the bias engine in exchange for a fee. Clients can submit analysis requests to the bias engine through submission of one or more queries or commands. For example, a game publisher could request an analysis of all FPS video games that are accessible to disabled persons and that have been reviewed by printed media magazines. The bias engine can map the request to the appropriate product properties or review attribute namespace to select a result set on which to conduct an analysis.

Step 240 includes the bias engine aggregating review scores derived from the review objects associated with one or more products having at least one common product property to form a composite review score. As discussed previously, the composite review scores can comprises multiple values, possibly in vector or N-tuple form, where each value corresponds to product properties. Review scores can also be weighted before folding them into the composite review score if desired. In some embodiments, the composite review score can be simple average of review scores while in other embodiments the composite review score can include weighting factors to adjust for relevance or other factors. For example, some review scores could be down-scaled because the review outlet providing the review is considered of distant relevance perhaps because the review outlet is from a different market or targets a different demographic. When determining bias of a specific review outlet, data from the specific review outlet can be removed from the composite score if desired.

Step 250 includes the bias engine generating one or more bias vectors for a specific review object, or possibly for an entire review outlet. The bias vector can include one or more bias metrics indicating how far the review object's data deviates from the composite review score. Each member of the vector (or the composite score) can be aligned with the product properties in a manner that indicates bias along product properties. For example, a review outlet might regularly rate an FPS game four points lower on a scale of 10 than an industry average. Thus, the review outlet appears to have a negative bias toward FPS games. Step 255 can optionally include weighting the review scores when generating the bias vector. Thus, a client conducting an analysis could obtain multiple bias vectors where each bias vector takes into account differences in weighting of the review scores. As mentioned previously, the review scores could be weighted based on market relevance of the review, perceived importance of the review outlet, or not weighted at all. If all three options were selected by the client, the client would obtain three different instances of the bias vector, which can result in very different recommendations.

Step 260, having the bias vector in hand, includes the bias engine configuring an output device (e.g., computer, printer, mobile phone, integrated development environment, etc.) to present a recommendation with respect to associating a product object with a review outlet based on the bias vector. The recommendation aids a client on how to position a product with respect to one or more review outlets. Alternatively, a product developer can learn which product properties should be incorporated in the product to generate a favorable review from a review outlet. Recommendations can include associating a product with a review outlet, avoiding such an association, indicating which outlets are most or least favorable to a product, or other suggestions.

One should appreciate that the product object information and review object information can vary with time. As new information becomes available, possibly by submission of new objects to the databases or through crawling product or review web sites in real-time, the composite review scores or product properties could also change with time. Therefore, step 263 can optionally include presenting the bias vector as a function of time via an output device. In such embodiments, a client can observe how a review outlet or even a specific reviewer shifts bias. Further, such information can be used to track trends to identify or predict when a review outlet might likely have favorable or unfavorable bias toward product properties.

Recommendations are considered to comprise quantitative analyses relating to how review outlets or products should or should not be associated with each other. Recommendations can include a listing, possibly ranked, of review outlets that are most favorable to a product. As the bias engine conducts many analyses on multiple review objects with respect to one or more product properties, the analyses of the review objects can result in a ranked listing illustrating which corresponding review outlets are most favorable to a target product. The ranking can be based on a favorability measure, which can be derived or calculated based on a review object's bias metrics deviation from the composite review score. As an example, bias metrics can comprise a normalized value representing the number of standard deviations away from a composite review score mean. Therefore, in some embodiments as illustrated by step 265, method 200 can include the bias engine presenting a favorability measure indicating how closely aligned the review outlet is with a product or product properties. A favorability measure can include a positive number of standard deviations away from the mean: 0.5σ, 1.0σ, 2.0σ, or other value. A negative number of standard deviations (e.g., −0.5σ, −1.0σ, −2.0σ, etc.) would indicate review outlets that are less favorable to a product.

Further, the ranked listing can be presented on a product property-by-product property basis where the favorability measure can have multiple values corresponding to the product properties. Step 267 can include segmenting the favorability measure by a number of product properties. For example, a review outlet might be considered more favorable because the reviewer regularly gives positive reviews for three or four features (e.g., game play, publisher, game design, etc.) of a game while the same review outlet might give negative reviews for other features (e.g., art work, use of color, dialog, etc.).

As briefly referenced early, the disclosed techniques can also utilizing information relating to media outlets in addition to review outlets. Another aspect of the inventive subject is considered to include analyzing product information or media outlet information to derive one or more universal characteristics representative of each type of object. The universal characteristics can take different forms depending on the desired approach or the desire results. In some embodiments the universal characteristics can be defined within a standardized namespace where elements of the namespace quantify or represent descriptive information relating to an object (e.g., product, media outlet, supply chain, review outlet, game, etc.). The elements of the namespace can include monetary values, release dates, supply chain information, franchise information, publisher data, designer data, writer data, or any other descriptive element. Furthermore, one can convert from a proprietary nomenclature to the universal namespace to provide a foundation for comparing disparate objects (e.g., products, media outlets, review outlets, etc.) even across wide, seemly unconnected, market boundaries.

One of the more preferred embodiments includes applying the following techniques to video games and game review outlets (e.g., blogs, game web site, game community, magazine, etc.). Contemplated universal characteristics in such a space can include readership of the outlet, demographics, frequency of reader visits, reach of the product, circulation, website unique visitors, type of products covered by a reviewer outlet, or other type of characteristic.

The universal characteristics of a target object can be determined through different approaches. Approaches can include converting proprietary data formats to the universal format, translating information to the universal namespace through one or more look-up tables, establishing weighted correlations among keywords or other data points and the universal namespace or other techniques. As an example, many media outlets or review outlets can be analyzed with respect to keywords or concepts. The concepts can be mapped on a cluster plot to determine potential groupings. Should groupings overlap or cluster unexpectedly, then the concepts might be related. Such clustering can be realized by grouping objects based on intermediary commonly shared characteristics.

When a correlation is established between products and media outlets (or review outlets), an analysis engine can determine a relevance distance between the two objects. The relevance distance can be considered a vector of weighted parameters were each element of the vector indicates how strongly or weakly correlated to the objects are. One should appreciate that existence of an element in the vector (or non-existence of the element) is considered useful information. Each element in the relevance distance can correspond to a single universal characteristics or even a combination of multiple characteristics where the element is reflective of function of two or more characteristics.

A relevance distance can indicate if two objects of interest (e.g., a video game and a review or media outlet) have a strong relevance. If so, the two objects should likely be associated with each other. One should keep in mind that the relevance distance can be considered a multi-valued data object where each element can have its own value indicating a relevance along a specific dimension. Such information can be quite useful when determining if specific features of a product should be promoted or even understated for a specific media outlet.

The relevance distance can be used for multiple purposes. Media or review outlets can be ranked according relevance to a product, or products can be ranked as being appropriate for a media outlet. Ranking can even occur with a fine level of granularity, down the feature level for example. Furthermore, through the use of the relevance distance one can aggregate product information from the various media outlets with respect to a specific product. When aggregating the product information, review scores for example, each media outlet's data can be weighted appropriately based on one or more values within the relevance difference. Thus, one can generate a more accurate perspective of a product.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of identifying a bias associated with product reviews, the method comprising:
providing access to a product database storing a plurality of product objects, the product objects each having product properties;
providing access to a review database storing a plurality of review objects, each review object representative of a product review of a product object and from a review outlet;
providing access to a bias engine communicatively coupled with the product database and the review database;
aggregating, by the bias engine, review scores derived from the review objects associated with one or more products having a common product property to form a composite review score;
generating, by the bias engine, a bias vector comprising bias metrics reflective of a review object's deviation from the composite review score; and
configuring, by the bias engine, an output device to present a recommendation with respect to associating a product object with a review outlet based on the bias vector.

2. The method of claim 1, wherein the recommendation includes associating a product corresponding to the product object with the review outlet.

3. The method of claim 1, wherein recommendation includes avoiding association of a product corresponding to the product object with the review outlet.

4. The method of claim 1, wherein the composite review score comprise a vector having elements associated with one or more product properties.

5. The method of claim 1, wherein the bias vector comprises at least two elements.

6. The method of claim 1, wherein the product properties include genre, category, size, shape, color, awareness, and marketing spend.

7. The method of claim 1, further comprising weighting the review scores when forming the bias vector.

8. The method of claim 1, further comprising presenting the bias vector as a function of time.

9. The method of claim 1, wherein the recommendation includes review outlets most favorable to a product.

10. The method of claim 1, wherein the recommendation includes review outlets least favorable to a product.

11. The method of claim 1, further comprising presenting a favorability measure with respect to elements of the bias vector.

12. The method of claim 11, further comprising segmenting the favorability measure by a number of product properties.
